(19) United States
(12) Patent Application Publication
(10) Pub. No.: US 2026/0138599 A1
(43) Pub. Date: May 21, 2026

(54) METHOD AND APPARATUS FOR GENERATING COLLISION-AVOIDANCE PATH

(71) Applicants: Hyundai Motor Company, Seoul (KR); Kia Corporation, Seoul (KR)

(72) Inventor: Sung Wook Lee, Hwaseong-si (KR)

(21) Appl. No.: 19/343,938

(22) Filed: Sep. 29, 2025

(30) Foreign Application Priority Data
Nov. 18, 2024 (KR) 10-2024-0164028

(51) Int. Cl. B60W 30/09; B60W 30/095; B60W 60/00

(52) U.S. Cl. CPC B60W 30/09; B60W 30/0953; B60W 30/0956; B60W 60/0015; B60W 2554/4041; B60W 2554/4044; B60W 2554/801

(57) ABSTRACT

In an embodiment a method includes receiving driving information of the vehicle and information of one or more targets, generating a candidate path set including a plurality of candidate paths, determining an avoidance path from the candidate path set, based on a binary search, wherein the avoidance path avoids a collision with the one or more targets, and driving the vehicle based at least in part on the avoidance path.

### CROSS-REFERENCE TO RELATED APPLICATIONS

This application claims the benefit of priority to Korean Patent Application No. 10-2024-0164028, filed on Nov. 18, 2024 in the Korea Intellectual Property Office, the entire contents of which are incorporated herein by reference.

### TECHNICAL FIELD

The present disclosure relates to a method and an apparatus for generating a collision-avoidance path. More particularly, the present disclosure relates to generating a path capable of avoiding a collision with one or more obstacles.

### BACKGROUND

The statements in this section merely provide background information related to the present disclosure and do not necessarily constitute prior art.

An advanced driver assistance system (ADAS) and an autonomous driving system have to recognize a surrounding environment of a vehicle, have to plan a driving path, and have to perform driving control. In particular, in order to prevent a collision between the vehicle and a surrounding obstacle (target), the ADAS or the autonomous driving system adopts a technique that allows the vehicle to evaluate a risk of collision with the surrounding obstacle (target) and to generate a path capable of avoiding the risk of collision.

In the related art in which a path for avoiding a single target is generated, when a plurality of targets exist around the vehicle, a target with the highest risk of collision is selected, and an avoidance path capable of avoiding the collision with that target is generated. The avoidance path generated in this way has a potential problem in that the vehicle may collide with another target while the vehicle is driven along the avoidance path.

The related art in which the path for avoiding multiple targets is generated includes a method for generating the avoidance path based on Rapidly-exploring Random Trees Star (RRT), a method for generating the avoidance path based on trees, and a method for selecting the avoidance path by generating multiple candidate paths.

According to the method for generating the avoidance path based on the RRT, a node is randomly sampled to generate a path to reach a target point, connecting the sampled node to a closest node is repeated, and a single path to reach a final target node is generated. In this method, an “optimal” path may be generated as the number of samples increases, but this problem has a time complexity of O(MKlogK) when the number of samples is K and the number of obstacles is M.

According to the method for generating the avoidance path based on trees, a path to reach the target point is generated after a given environment is configured as a tree graph, connecting the nodes is repeated, and the single path to reach a target node from a root node is generated. In the present disclosure, a shortest path may be generated within a given tree, but has a time complexity of O(M(V+E)) when the number of nodes is V, the number of edges is E, and the number of targets is M.

According to the method for selecting the avoidance path by generating the multiple candidate paths, whether the collision occurs with the targets is checked for each of the avoidance paths to select the avoidance path which does not collide with the targets. In the present disclosure, as a large number of the candidate paths are generated, a possibility of generating the avoidance path which does not collide with the targets increases. However, the method has a time complexity of O(NM) when the number of the candidate paths is N and the number of the targets is M.

According to a technique for generating the avoidance path in the related art in which multiple targets are considered, a safer avoidance path may be generated, compared to a technique for generating the avoidance path in which only a single target is considered, but has a disadvantage in that a very large amount of computation is required as described above. Therefore, there is a need for a technique capable of generating the avoidance path with a smaller amount of computation while the avoidance path is generated by considering multiple targets.

### SUMMARY

In view of the above, embodiments provide a method and an apparatus for generating an avoidance path capable of avoiding a collision with one or more targets.

In view of the above, embodiments provide a method and an apparatus for computationally and efficiently exploring an avoidance path by exploring the avoidance path based on a heuristic method.

In view of the above, embodiments provide a method and an apparatus for computationally and efficiently exploring the avoidance path by exploring the avoidance path based on a binary search.

Technical results to be achieved by the present disclosure are not limited to those described above, and other technical results not mentioned above may also be clearly understood from the detailed descriptions given below by those skilled in the art to which the present disclosure belongs.

An embodiment of the present disclosure provides a method for generating an avoidance path of a vehicle to avoid a collision with one or more targets, the method comprising: receiving driving information of the vehicle and information of the one or more targets; generating a candidate path set comprising a plurality of candidate paths; and determining the avoidance path from the candidate path set, based on a binary search. A method for generating an avoidance path of a vehicle to avoid a collision with one or more targets, the method comprising: receiving driving information of the vehicle and information of the one or more targets; generating a candidate path set comprising a plurality of candidate paths; and determining the avoidance path from the candidate path set, based on a binary search.

Another embodiment of the present disclosure provides an apparatus for generating an avoidance path of a vehicle to avoid a collision with one or more targets, the apparatus comprising: at least one memory that stores commands; and at least one processor, wherein the at least one processor executes the commands to: receive driving information on the vehicle and information of the one or more targets, generate a candidate path set comprising a plurality of candidate paths, and determine the avoidance path from the candidate path set, based on a binary search.

According to one embodiment of the present disclosure, the N-number of avoidance paths are explored for the M-number of targets, based on a heuristic method and a binary search. In this manner, there is an advantageous effect in that the avoidance paths can be explored with a time complexity of O(MlogN).

According to one embodiment of the present disclosure, a candidate path is generated and a heuristic value is calculated in an S-N coordinate system rather than an orthogonal coordinate system. In this manner, there is an advantageous effect in that the avoidance path can be generated regardless of a curvature of a road.

According to one embodiment of the present disclosure, a collision situation between a vehicle and a target is evaluated, based on a lateral velocity, a lateral distance, a predicted collision direction in the S-N coordinate system. In this manner, there is an advantageous effect in that a best candidate path can be explored.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a block diagram schematically illustrating a path generation apparatus according to one embodiment of the present disclosure.

FIG. 2 is a diagram illustrating an example of a plurality of candidate paths generated by the path generation apparatus.

FIG. 3 is an example diagram for describing an example of a method for determining whether a collision occurs between a vehicle and a target.

FIG. 4 is a flowchart for describing a method for exploring an avoidance path according to one embodiment of the present disclosure.

FIGS. 5 to 8E are example diagrams for describing an example of selecting an avoidance path according to one embodiment of the present disclosure.

FIG. 9 is a block diagram schematically illustrating an exemplary computing device which may be used to implement a method or an apparatus according to the present disclosure.

### DETAILED DESCRIPTION OF ILLUSTRATIVE EMBODIMENTS

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

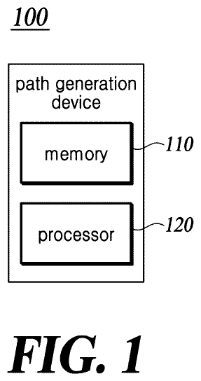

FIG. 1 is a block diagram schematically illustrating a path generation apparatus according to one embodiment of the present disclosure.

A path generation apparatus (100) includes a memory (110) and a processor (120). The path generation apparatus (100) may be implemented in a form of an incorporated device, a server, an electronic device, and the like in an autonomous driving system. All blocks illustrated in FIG. 1 are not essential components, and some blocks included in the path generation apparatus (100) may be added, changed, or deleted in other embodiments. Meanwhile, the components illustrated in FIG. 1 represent functionally distinct elements, and may be implemented in a form in which at least one or more components are integrated with each other in an actual physical environment. It will be appreciated while one processor and memory are illustrated, there may be multiple processors and memories.

The memory (110) stores data and commands which are required for an operation of the path generation apparatus (100).

The memory (110) may store driving information of a vehicle, which is acquired by using at least one sensor included in the vehicle. The driving information of the vehicle may include a velocity, acceleration, a steering angle, a yaw rate, a pedal amount, and lane information of the vehicle. For example, the lane information may be expressed in a form of a third-order polynomial or a B-spline curve, but the configuration is not limited thereto.

The memory (110) may store information on one or more targets, which is acquired by using at least one sensor included in the vehicle. The information of the target may include a position, a velocity, acceleration, a direction, and a yaw rate of the target. Here, the target is an obstacle to be avoided by a vehicle, and includes other vehicles, pedestrians, obstacles, and the like around the vehicle. The position of the target may be defined in an orthogonal coordinate system in which a current position of the vehicle is set as an origin.

The processor (120) controls an overall operation of the path generation apparatus (100). The processor (120) may be implemented with one or more processors. The processor (120) may execute commands stored in the memory (110).

The processor (120) may convert position coordinates of the target in the orthogonal coordinate system into position coordinates in an S-N coordinate system, based on information of a lane in which a vehicle is driven. Here, the orthogonal coordinate system may be defined as the orthogonal coordinate system in which the current position of the vehicle is set as the origin. In addition, the S-N coordinate system may be defined as the S-N coordinate system in which the current position of the vehicle is set as the origin, a driving direction of the vehicle is set as an S-axis, and a direction perpendicular to the driving direction is set as an N-axis. The conversion from the orthogonal coordinate system to the S-N coordinate system may be performed by an approximate or numerical analysis method, but the configuration is not limited thereto.

The processor (120) may generate a plurality of candidate paths for exploring the avoidance path. The candidate paths are generated, based on driving information (steering angle, acceleration, velocity, and the like) of the vehicle at a current time. Here, the candidate path may be expressed in the S-N coordinate system. In addition, for example, the candidate path may be expressed in a form of a polynomial equation, a cubic equation, a quintic equation, and the like, but the configuration is not limited thereto. In addition, when the candidate path is generated, a path in which driving stability is considered may be generated, based on acceleration, jerk, and the like, but the configuration is not limited thereto.

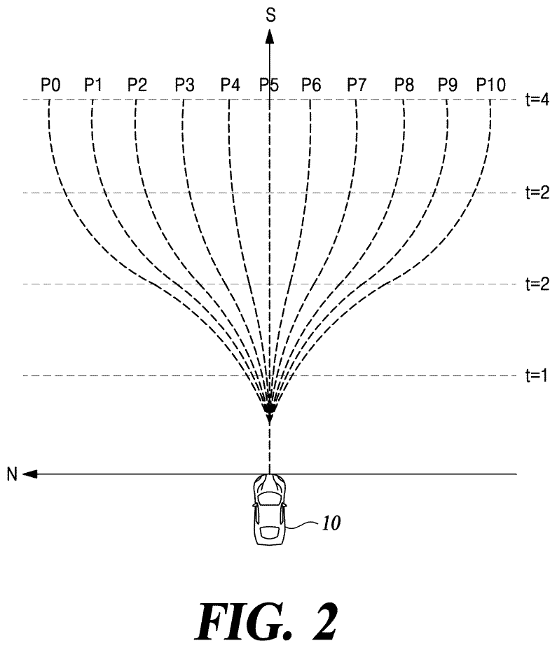

FIG. 2 is a diagram illustrating an example of the candidate path set generated by the path generation apparatus (100). In FIG. 2, P0 to P10 are the candidate paths generated in the S-N coordinate system by the path generation apparatus (100). In the example in FIGS. 2, 11 candidate paths are generated, but the number of the candidate paths is not limited thereto.

A length of the candidate path may be defined as a distance in which the vehicle may be driven during a path prediction time. For example, as illustrated in FIG. 2, when the path generation apparatus (100) predicts a path from the current time to a time 4 seconds later, and the velocity of the vehicle is 10 m/s, the length of the candidate path may be 40 m. A start point of the candidate path is the current position of the vehicle, that is, the position of the origin (0,0)_{SN} in the S-N coordinate system, and an end point of the candidate path may be located on a straight line perpendicular to the S-axis. For example, when a longitudinal length of the candidate path is 40 m and a maximum lateral length of the candidate path is 10 m, the end point of the candidate path is located on a straight line connecting (40, −10)_{SN} and (40,10)_{SN}. A maximum left lateral length and a maximum right lateral length of the candidate path may be the same, but the configuration is not limited thereto. In addition, the end points of the candidate paths may be located at an equal interval, but the configuration is not limited thereto.

The processor (120) may select the avoidance path from the plurality of candidate paths. In order to check whether the collision occurs between the vehicle and the target when the vehicle is driven along a specific candidate path, the processor (120) may perform collision determination, or an evaluation of a potential collision, on the specific candidate path.

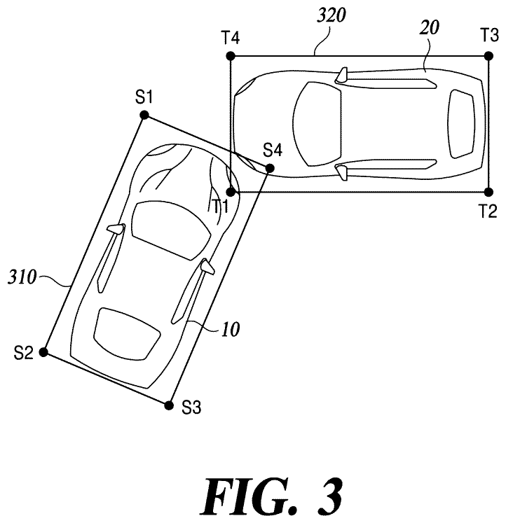

FIG. 3 is an example diagram for describing an example of a method for determining whether a collision occurs between a vehicle (10) and a target (20). The processor (120) may determine whether the collision occurs between the vehicle (10) and the target (20) at a specific time, based on a bounding box of the vehicle (10) and the target (20). The bounding box is a virtual box surrounding a specific object, and the processor (120) may calculate coordinates of vertices of the bounding box, based on position coordinates of the object and a size of the object at the specific time. Referring to FIG. 3, the processor (120) may calculate coordinates of vertices (S1 to S4) of a bounding box (310) surrounding the vehicle (10) and coordinates of vertices (T1 to T4) of a bounding box (320) surrounding the target (20) on which collision determination is to be performed.

For each of the vertices (T1 to T4) of the target (20), the processor (120) checks whether the vertex is located in the bounding box (310) of the vehicle (10). For example, when whether T1 is located in the bounding box (310) of the vehicle (10) is checked, the processor (120) performs four outer product operations ((S1S2)^{→}×(S2T1)^{→}, (S2S3)^{→}×(S3T1)^{→}, (S3S4)^{→}×(S4T1)^{→}, (S4S1)⁴³ ×(S1T1)^{→}), and compares signs of respective operation results. When the signs of the respective operation results are the same, it is determined that T1 is located in the bounding box (310) of the vehicle (10), and when the signs of the respective operation results are not the same, it is determined that T1 is not located in the bounding box (310) of the vehicle (10). However, another inspection method for determining whether a specific point is located in the bounding box may also be used.

The processor (120) may determine that the vehicle (10) and the target (20) collide with each other when at least one of the vertices (T1 to T4) of the target (20) is located in the bounding box (310) of the vehicle (10). On the other hand, the processor (120) may determine that the vehicle (10) and the target (20) do not collide with each other when all of the vertices (T1 to T4) of the target (20) are located outside the bounding box (310) of the vehicle (10).

In another embodiment, the processor (120) may determine whether the vehicle (10) and the target (20) collide with each other by checking whether each of the vertices (S1 to S4) of the bounding box (310) of the vehicle (10) is located in the bounding box (320) of the target (20).

In another embodiment, the processor (120) may determine whether the vehicle (10) and the target (20) collide with each other by checking whether each of edges (S1-S2, S2-S3, S3-S4, and S4-S1) of the bounding box (310) of the vehicle (10) intersects any one of edges (T1-T2, T2-T3, T3-T4, and T4-T1) of the bounding box (320) of the target (20).

When the processor (120) determines that the collision between the vehicle (10) and the target occurs on the specific candidate path, the processor (120) performs the collision determination on another candidate path. The processor (120) may select another candidate path, based on a heuristic method. For example, the processor (120) may select the next candidate path in the candidate paths located on a left side of the candidate path on which the collision determination is performed when a value of a heuristic function is smaller than a predefined reference value, and may select the next candidate path in the candidate paths located on a right side of the candidate path on which the collision determination is performed when the value of the heuristic function is greater than the predefined reference value.

Equation 1 illustrates an example of the heuristic function.

$$h ( x ) = {w}_{1} {V}_{N} + {w}_{2} {D}_{N} + {w}_{3} {P}_{c} \qquad [ Equation 1 ]$$

In Equation 1, V_{N} represents an N-axis velocity of the target in the S-N coordinate system, that is, a lateral velocity. When the target moves from the right side to the left side of the vehicle (10) in the S-N coordinate system, V_{N} may have a positive value, and when the target moves from the left side to the right side of the vehicle (10), V_{N} may have a negative value. Since the sign of V_{N} is defined as above, the candidate path located in a direction opposite to the driving direction of the target may be selected.

In Equation 1, D_{N} means a distance in an N-axis direction of the target in the S-N coordinate system, that is, a lateral distance. When the target is located on the left side of the vehicle (10) in the S-N coordinate system, D_{N} has the positive value, and when the target is located on the right side of the vehicle (10), D_{N} has the negative value. Since the sign of D_{N} is defined as above, the candidate path located in a wide area where the collision between the vehicle (10) and the target can be avoided may be selected.

In Equation 1, P_{c} represents a direction in which the target collides with the vehicle (10). When the collision occurs on the left side of the vehicle (10), P_{c} may have the positive value, and when the collision occurs on the right side of the vehicle (10), P_{c} may have the negative value. Since the sign of Pc is defined as above, the candidate path located in the direction opposite to a predicted collision direction may be selected. The direction in which the target collides with the vehicle (10) may be determined, based on a collision determination result. As an example, referring to FIG. 3, when S1 and/or S2 in the bounding box (310) of the vehicle (10) are located in the bounding box (320) of the target, the processor (120) may determine that the collision occurs on the left side of the vehicle (10), and when S3 and/or S4 are located in the bounding box (320) of the target, the processor (120) may determine that the collision occurs on the right side of the vehicle (10). In another embodiment, the processor (120) may determine that the collision occurs on the left side of the vehicle (10) when the edges S1-S2 of the bounding box (310) of the vehicle (10) intersect the edge of the bounding box (320) of the target, the processor (120) may determine that the collision occurs on the right side of the vehicle (10) when the edges S3-S4 intersect the edge of the bounding box (320) of the target. However, the present disclosure is not limited to the embodiments, and other methods for determining the collision direction of the target may be used.

In Equation 1, w₁ to w₃ represent weights of variables in the heuristic function. The weights may be set to a constant value, or may be differently set depending on a driving environment, a target, and the like. For example, when the target where the collision occurs is a static target, w₂ may be set to a great value, and when the target where the collision occurs is a dynamic target, w₁ may be set to a great value.

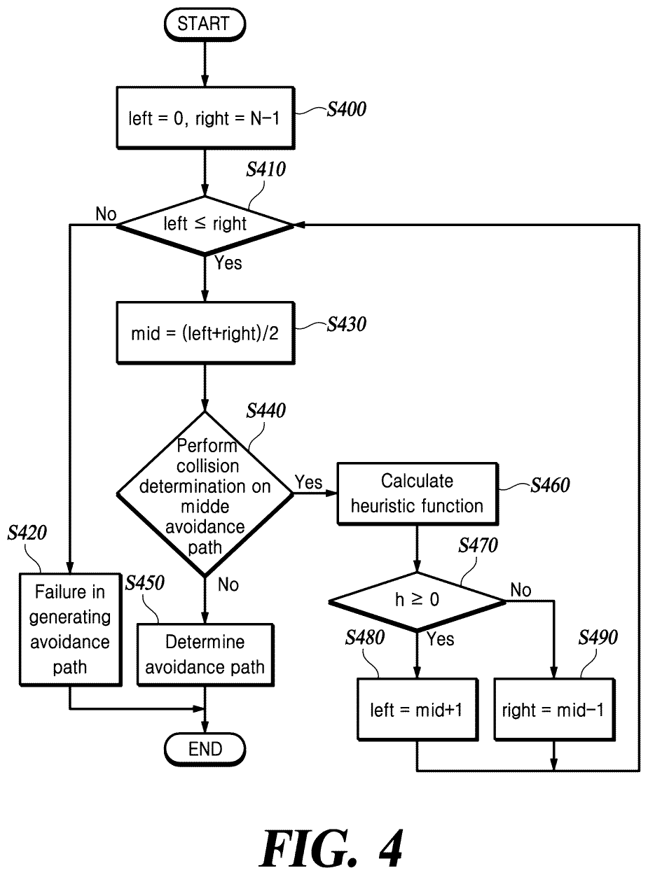

FIG. 4 is a flowchart for describing a method for exploring an avoidance path according to one embodiment of the present disclosure.

The processor (120) sequentially assigns a number to each of the plurality of candidate paths. For example, when the N-number of candidate paths are generated, numbers 0 to N-1 are sequentially assigned from a leftmost candidate path. Accordingly, 0 is assigned to a leftmost candidate path, and N-1 is assigned to a rightmost candidate path.

The processor (120) substitutes 0 into a variable left which represents the candidate path located at a leftmost position in the current candidate paths, and substitutes N-1 into a variable right which represents the candidate path located at a rightmost position in the current candidate paths (S400).

The processor (120) determines whether a value of the left is equal to or smaller than a value of the right (S410). When the value of the left exceeds the value of the right (S410-NO), the processor (120) determines that the avoidance path does not exist in the candidate paths, and completes exploring the avoidance path (S420). When the value of the left is equal to or smaller than the value of the right (S410-YES), the processor (120) substitutes (left+right)/2 into a variable mid which represents a middle value of the left and the right (S430).

The processor (120) performs the collision determination on the candidate path corresponding to the mid (S430). When the collision between the vehicle and the target does not occur (S440-NO), the processor (120) selects the candidate path corresponding to the mid, as the avoidance path, and completes exploring the avoidance path (S450). When the collision between the vehicle and the target occurs (S440-YES), the processor (120) calculates the value of the heuristic function in Equation 1 (S460 ).

When the value of the heuristic function is equal to or greater than 0 (S470-YES), the processor (120) substitutes mid+1 into the left, and proceeds to a process S410 to continue exploring the avoidance path (S480). When the value of the heuristic function is smaller than 0 (S470 -NO), the processor (120) substitutes mid−1 into the right, and proceeds to a process S410 to continue exploring the avoidance path (S490).

When the method for exploring the avoidance path according to the present disclosure is used, the avoidance path may be computationally and efficiently generated. More specifically, when the N-number of candidate paths which can avoid the M-number of targets, the time complexity of the collision determination for one candidate path is O(M), and the time complexity of the binary search for the N-number of candidate paths is O(logN). Therefore, a total time complexity is O(MlogN).

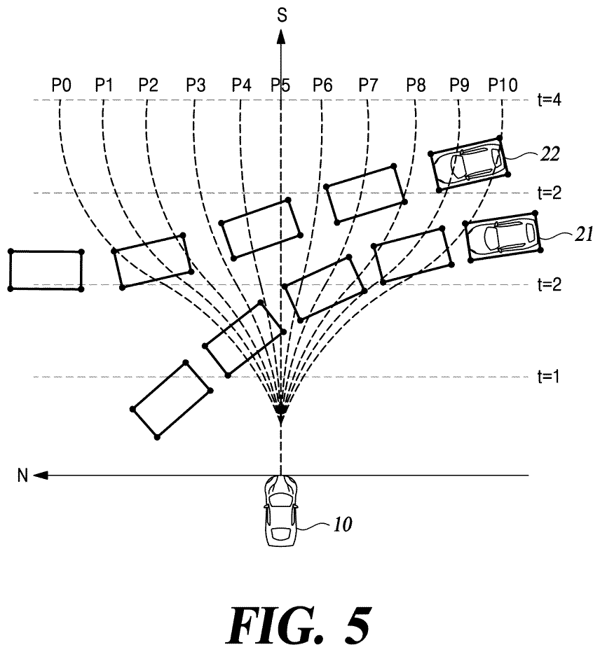

FIGS. 5 to 8E are example diagrams illustrating an example of selecting for the avoidance path according to one embodiment of the present disclosure.

FIG. 5 illustrates candidate paths (P0 to P10) generated by the path generation apparatus (100) to explore the avoidance path and predicted paths of a first target (2) and a second target (22). In this example, the predicted path of the target may be expressed as a set of the bounding boxes.

In this example, it is assumed that a prediction time is 4 seconds, a time interval is set to 1 second, and the path generation apparatus (100) generates 11 candidate paths (P0 to P10). In addition, it is assumed that the vehicle (10) detects two targets (21 and 22) in this example. Therefore, the path generation apparatus (100) generates 5 (=4 seconds/1 second+1) bounding boxes for each target. For example, the bounding boxes of the first target (21) include the bounding box at the current time, the bounding box at 1 second later, the bounding box at 2 seconds later, the bounding box at 3 seconds later, and the bounding box at 4 seconds later.

Meanwhile, in this example, the length of the prediction time (4 seconds) and the time interval (1 second) are values arbitrarily set for the convenience of description, and the configuration is not limited thereto. For example, the length of the prediction time may be longer or shorter than 4 seconds, and may be a variable value depending on the driving environment and the like rather than a fixed value. In addition, the time interval may be longer or shorter than 1 second, and may be a variable value depending on the driving environment and the like rather than a fixed value. In particular, the time interval may be set to a value of 0.1 seconds or smaller, which is a value used in actual commercial vehicles.

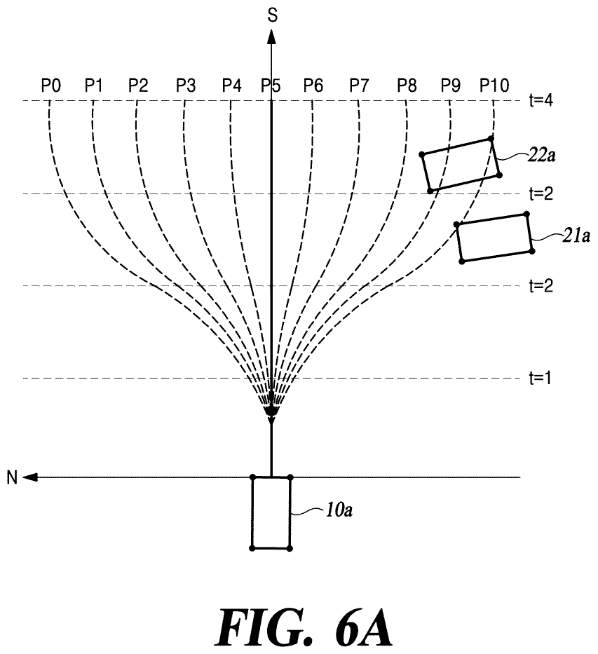

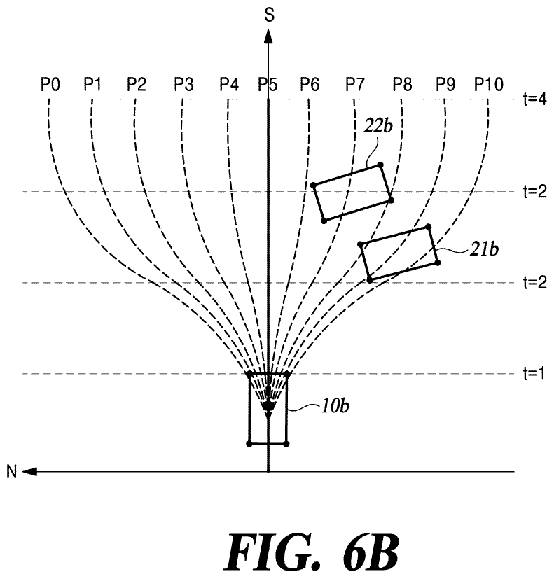

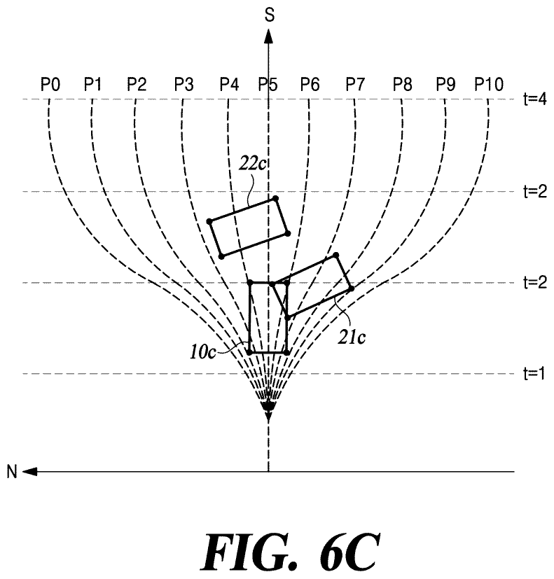

FIGS. 6A to 6C are example diagrams illustrating a first process of exploring the path. The path generation apparatus (100) performs the collision determination on a path P5 which is the path located in a center in the candidate paths.

Referring to FIG. 6A, the path generation apparatus (100) performs the collision determination between the bounding box (10a) of the vehicle (10) and the bounding boxes (21a and 22a) of the targets at time 0s. That is, the path generation apparatus (100) performs the collision determination between the bounding box (10a) of the vehicle (10) and the bounding box (21a) of the first target (21), and performs the collision determination between the bounding box (10a) of the vehicle (10) and the bounding box (22a) of the second target (22). Since it is determined that the vehicle (10) does not collide with the first target (21) and the second target (22) at time 0s, referring to FIG. 6B, the path generation apparatus (100) performs the collision determination between the bounding box (10b) of the vehicle (10) and the bounding boxes (21b and 22b) of the targets at time 1s. Since it is determined that the vehicle (10) does not collide with the first target (21) and the second target (22) at time 1s, referring to FIG. 6C, the path generation apparatus (100) performs the collision determination between the bounding box (10c) of the vehicle (10) and the bounding boxes (21c and 22c) of the targets at time 2s.

At time 2s, since it is determined that the vehicle (10) collides with the first target (21) and the second target (22), the path generation apparatus (100) calculates the heuristic function to select the next candidate path. For convenience of description, it is assumed that the heuristic function in this example is the heuristic function in Equation 1 in which all weights except w3 are 0. Referring to FIG. 6C, since an upper right corner of the bounding box (10c) of the vehicle (10) is located in the bounding box (21c) of the first target (21), the value of the heuristic function becomes negative.

Since the value of the heuristic function is negative, the path generation apparatus (100) selects P2 which is the path located in the center in the candidate paths located on the left side of the current path P5, as the next candidate path.

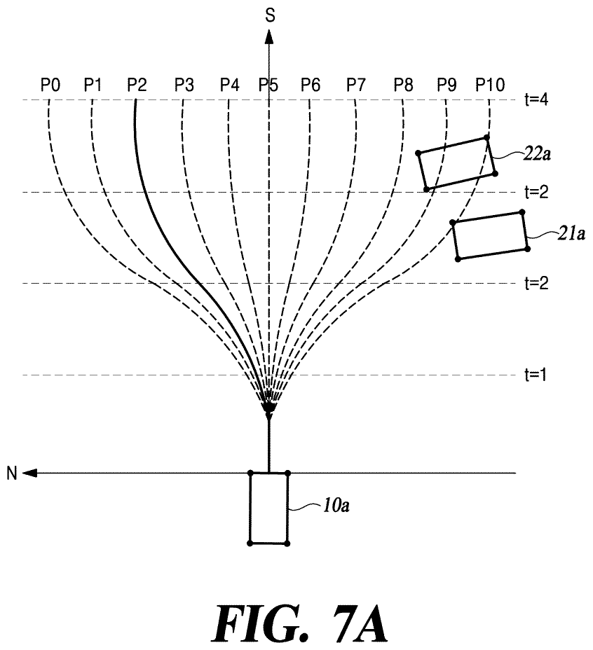

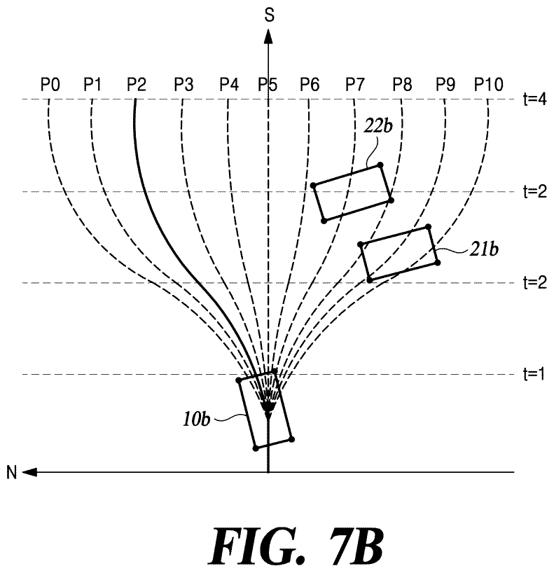

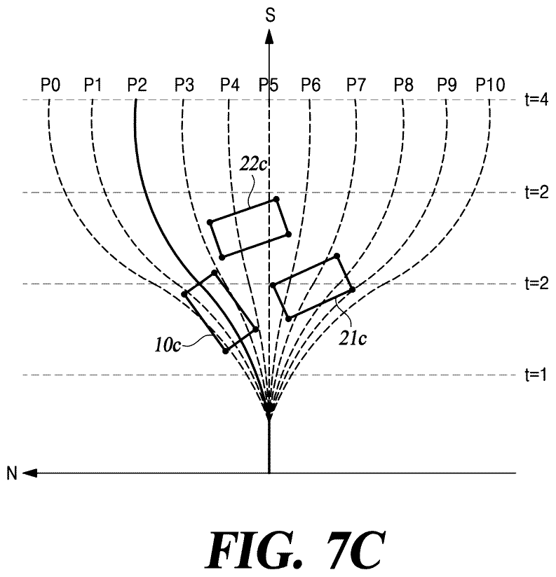

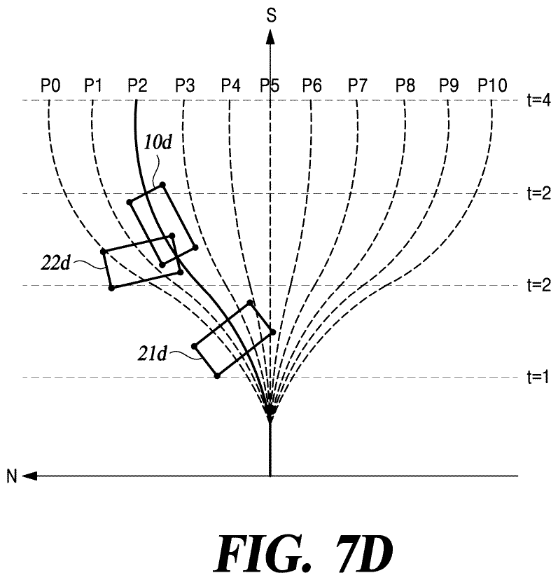

FIGS. 7A to 7D are example diagrams illustrating a second process of exploring the path. The path generation apparatus (100) performs the collision determination on the path P2.

Referring to FIG. 7A, the path generation apparatus (100) performs the collision determination between the bounding box (10a) of the vehicle (10) and the bounding boxes (21a and 22a) of the targets at time 0s. Since it is determined that the vehicle (10) does not collide with the first target (21) and the second target (22) at time 0s, referring to FIG. 7B, the path generation apparatus (100) performs the collision determination between the bounding box (10b) of the vehicle (10) and the bounding boxes (21b and 22b) of the targets at time 1s. Since it is determined that the vehicle (10) does not collide with the first target (21) and the second target (22) at time 1s, referring to FIG. 7C, the path generation apparatus (100) performs the collision determination between the bounding box (10c) of the vehicle (10) and the bounding boxes (21c and 22c) of the targets at time 2s. Since it is determined that the vehicle (10) does not collide with the first target (21) and the second target (22) at time 2s, referring to FIG. 7D, the path generation apparatus (100) performs the collision determination between the bounding box (10d) of the vehicle (10) and the bounding boxes (21d and 22d) of the targets at time 3s.

Since it is determined that the vehicle (10) collides with the first target (21) and the second target (22) at time 3s, the path generation apparatus (100) calculates the heuristic function to select the next candidate path. Referring to FIG. 7D, since a lower left corner of the bounding box (10d) of the vehicle (10) is located in the bounding box (22d) of the second target (22), the value of the heuristic function becomes positive.

Since the value of the heuristic function is positive, the path generation apparatus (100) selects P3 which is the path located at the center in the candidate paths located between paths P2 and P5, as the next candidate path.

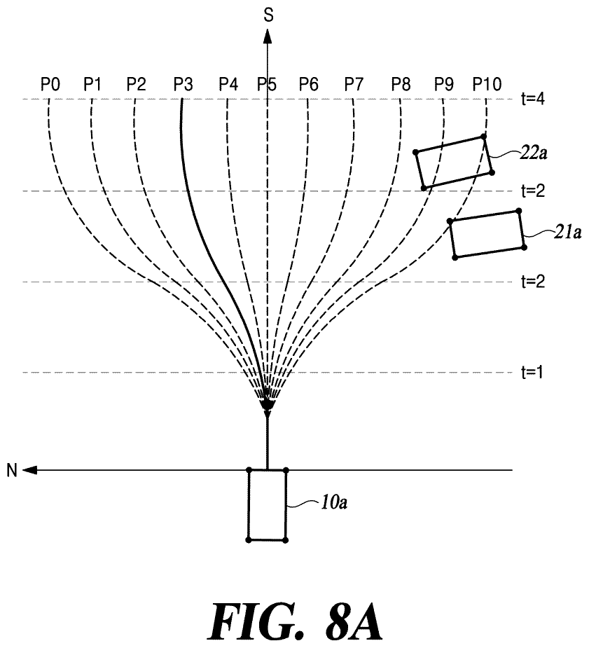

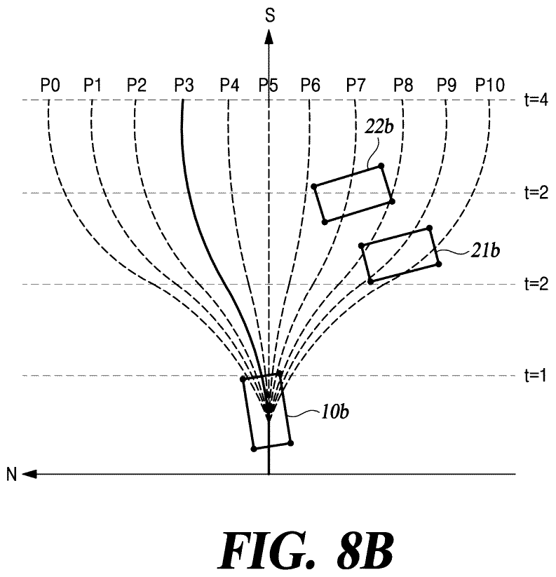

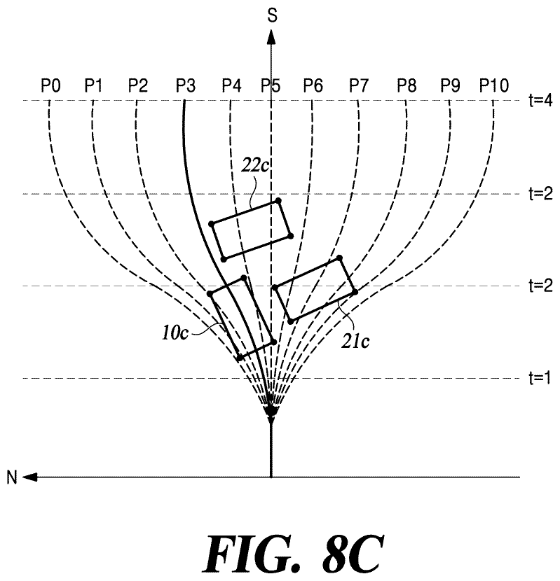

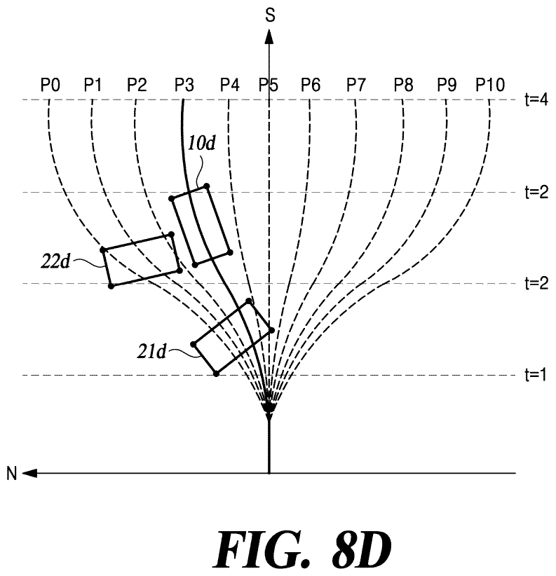

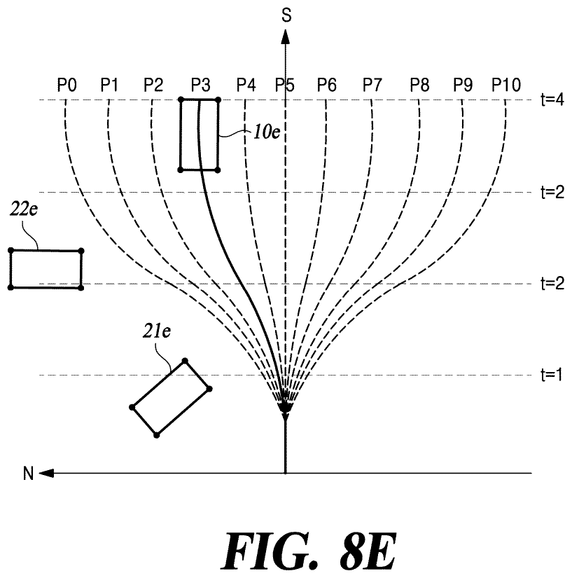

FIGS. 8A to 8E are examples illustrating a third process of exploring the path. The path generation apparatus (100) performs the collision determination on the path P3.

Referring to FIG. 8A, the path generation apparatus (100) performs the collision determination between the bounding box (10a) of the vehicle (10) and the bounding boxes (21a and 22a) of the targets at time 0s. Since it is determined that the vehicle (10) does not collide with the first target (21) and the second target (22) at time 0s, referring to FIG. 8B, the path generation apparatus (100) performs the collision determination between the bounding box (10b) of the vehicle (10) and the bounding boxes (21b and 22b) of the targets at time 1s. Since it is determined that the vehicle (10) does not collide with the first target (21) and the second target (22) at time 1s, referring to FIG. 8C, the path generation apparatus (100) performs the collision determination between the bounding box (10c) of the vehicle (10) and the bounding boxes (21c and 22c) of the targets at time 2s. Since it is determined that the vehicle (10) does not collide with the first target (21) and the second target (22) at time 2s, referring to FIG. 8D, the path generation apparatus (100) performs the collision determination between the bounding box (10d) of the vehicle (10) and the bounding boxes (21d and 22d) of the targets at time 3s. Since it is determined that the vehicle (10) does not collide with the first target (21) and the second target (22) at time 3s, referring to FIG. 8E, the path generation apparatus (100) performs the collision determination between the bounding box (10e) of the vehicle (10) and the bounding boxes (21e and 22e) of the targets at time 4s.

Since it is determined that the vehicle (10) does not collide with the first target (21) and the second target (22) until a last prediction time, the path generation apparatus (100) finally selects the path P3 as the avoidance path.

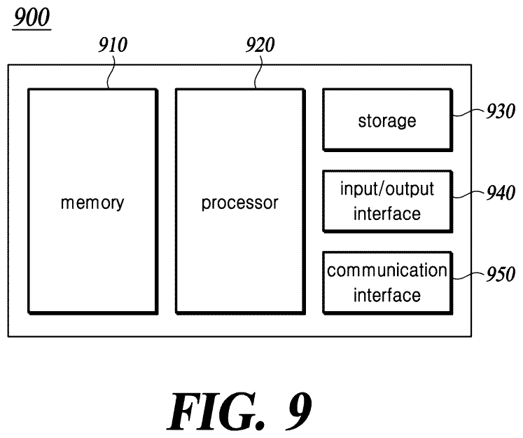

FIG. 9 is a block diagram schematically illustrating an exemplary computing device which may be used to implement a method or an apparatus according to the present disclosure.

A computing device (900) may include some or all of a memory (910), a processor (920), a storage (930), an input/output interface (940), and a communication interface (950). The computing device (900) may structurally and/or functionally include at least a portion of the apparatus according to the present disclosure. The computing device (900) may be not only a stationary computing device such as a desktop computer and a server, but also a mobile computing device such as a laptop computer, a smart phone, and an automotive electronic device. The computing device (900) may be implemented as any specialized hardware accelerator capable of efficiently processing operations for an artificial intelligence model. For example, the computing device (900) may include a graphic processing unit (GPU), a Tensor Processing Unit (TPU), or a neural processing unit (NPU).

The memory (910) may store a program that causes the processor (920) to perform a method or an operation according to various embodiments of the present disclosure. For example, the program may include a plurality of commands which can be executed by the processor (920), and the above-described method or operation may be performed by causing the processor (920) to execute the plurality of commands. The memory (910) may be a single memory or a plurality of memories. In this case, information required for performing the method or the operation according to various embodiments of the present disclosure may be stored in a single memory, or may be divided and stored in the plurality of memories. When the memory (910) includes the plurality of memories, the plurality of memories may be physically separated. The memory (910) may include at least one of a volatile memory and a nonvolatile memory. The volatile memory includes a static random access memory (SRAM) or a dynamic random access memory (DRAM), and the nonvolatile memory includes a flash memory.

The processor (920) may include at least one core capable of executing at least one command. The processor (920) may execute the commands stored in the memory (910). The processor (920) may be a single processor or a plurality of processors.

The storage (930) maintains stored data even when power supplied to the computing device (900) is cut off. For example, the storage (930) may include the nonvolatile memory, or may include storage media such as a magnetic tape, an optical disk, and a magnetic disk. The program stored in the storage (930) may be loaded into the memory (910) before being executed by the processor (920). The storage (930) may store a file written in a programming language, and the program generated from the file by a compiler or the like may be loaded into the memory (910). The storage (930) may store data to be processed by the processor (920) and/or data processed by the processor (920).

The input/output interface (940) may provide an interface with an input device such as a keyboard and a mouse and/or an output device such as a display device and a printer. The user may trigger the processor (920) to execute the program through the input device and/or may check a processing result of the processor (920) through the output device.

The communication interface (950) may provide access to an external network. The computing device (900) may communicate with other devices through the communication interface (950).

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed embodiments. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed embodiments are not to be limited by the above explicitly described embodiments but by the claims and equivalents thereof.

What is claimed is:

1. A method for driving a vehicle, the method comprising:
receiving driving information of the vehicle and information of one or more targets;
generating a candidate path set including a plurality of candidate paths;
determining an avoidance path from the candidate path set, based on a binary search, wherein the avoidance path avoids a collision with the one or more targets; and
driving the vehicle based at least in part on the avoidance path.

2. The method of claim 1, further comprising:
converting position coordinates of the one or more targets in an orthogonal coordinate system into position coordinates in an S-N coordinate system, based on lane information, before the generating the candidate path set.

3. The method of claim 1, wherein each of the plurality of candidate paths is a cubic equation or a B-spline curve.

4. The method of claim 1, wherein the determining the avoidance path comprises:
repeating
selecting a middle candidate path from the candidate path set,
determining if the vehicle has a potential collision with at least one target if the vehicle drives along the middle candidate path,
determining the middle candidate path as the avoidance path based at least in part on determining the vehicle does not collide with the at least one target, and
excluding the middle candidate path, and a right candidate path or a left candidate path of the middle candidate path from the candidate path set based at least in part on determining that the vehicle collides with the at least one target,
until the avoidance path is determined or the candidate path is not selectable from the candidate path set.

5. The method of claim 4, wherein the determining the potential collision comprises a selected on or more of:
determining whether at least one vertex of a bounding box of the target is located in a bounding box of the vehicle; or
determining whether at least one vertex of the bounding box of the vehicle is located in the bounding box of the target.

6. The method of claim 4, wherein the determining the potential collision comprises determining whether at least one edge of a bounding box of the target intersects at least one edge of a bounding box of the vehicle.

7. The method of claim 4, wherein the excluding comprises calculating a heuristic value, based on at least one of a lateral velocity of the at least one target and a lateral distance between the at least one target and the vehicle, and a direction of the potential collision, and
excluding the right candidate path or the left candidate path of the middle candidate path, based on the heuristic value.

8. The method of claim 7, wherein the direction of the collision is determined based on one or more vertexes of a bounding box of the vehicle located in a bounding box of the target.

9. An apparatus for driving a vehicle, the apparatus comprising:
at least one processor; and
a non-transitory computer-readable storage media storing programming for execution by the at least one processor, the programming comprising instructions to:
receive driving information of the vehicle and information of one or more targets;
generate a candidate path set including a plurality of candidate paths;
determine an avoidance path from the candidate path set, based on a binary search, wherein the avoidance path avoids a collision with the one or more targets; and
drive the vehicle based at least in part on the avoidance path.

10. The apparatus of claim 9, wherein the programming further comprising instructions to:
convert position coordinates of the one or more targets in an orthogonal coordinate system into position coordinates in an S-N coordinate system, based on lane information, before the generating the candidate path set.

11. The apparatus of claim 9, wherein each of the plurality of candidate paths is a cubic equation or a B-spline curve.

12. The apparatus of claim 9, wherein the programming for determining the avoidance path comprises further instructions to:
repeat
select a middle candidate path from the candidate path set,
determine if the vehicle has a potential collision with at least one target if the vehicle drives along the middle candidate path,
determine the middle candidate path as the avoidance path based at least in part on the determining the vehicle does not collide with the at least one target, and
exclude the middle candidate path, and a right candidate path or a left candidate path of the middle candidate path from the candidate path set based at least in part on determining that the vehicle collides with the at least one target,
until the avoidance path is determined or the candidate path is not selectable from the candidate path set.

13. The apparatus of claim 12, wherein the programming for determining the potential collision comprises further instructions for a selected on or more of:
determine whether at least one vertex of a bounding box of the target is located in a bounding box of the vehicle; or
determine whether at least one vertex of the bounding box of the vehicle is located in the bounding box of the target.

14. The apparatus of claim 12, wherein the programming for first determining the potential collision comprises determining whether at least one edge of a bounding box of the target intersects at least one edge of a bounding box of the vehicle.

15. The apparatus of claim 12, wherein the programming for excluding comprises further instructions to
calculate a heuristic value, based on at least one of a lateral velocity of the at least one target and a lateral distance between the at least one target and the vehicle, and a direction of the collision, and
exclude the right candidate path or the left candidate path of the middle candidate path, based on the heuristic value.

16. The apparatus of claim 15, wherein direction of the collision is determined based on one or more vertexes of a bounding box of the vehicle located in a bounding box of the target.

17. A non-transitory computer-accessible media storing instructions for generating an avoidance path for driving a vehicle, wherein the avoidance path avoids a collision with one or more targets, that, when accessed by at least one processor, cause the at least one processor to perform:
receiving driving information of the vehicle including at least one of velocity, acceleration, steering angle, yaw rate, pedal amount, and lane information of the vehicle;
receiving information of the one or more targets;
generating a candidate path set including a plurality of candidate paths;
determining the avoidance path for driving the vehicle from the candidate path set, based at least in part on a binary search.

18. The media of claim 17, wherein the instructions include further instructions to perform:
determining, for selected ones of the targets, information including at least one of position, velocity, acceleration, direction, and yaw rate.

19. The media of claim 17, wherein the instructions for determining the avoidance path include further instructions to perform:
calculating a heuristic value based at least in part on
a lateral velocity of the one or more target,
a lateral distance between the at least one target and the vehicle, and
a collision direction.

20. The media of claim 19, wherein the instructions for calculating the heuristic value include further instructions to perform:
assigning a respective heuristic weighting factor to each of the lateral velocity, the later distance and the collision direction; and
calculating the heuristic value based at least in part on the respective heuristic weighting to prioritize collision avoidance decision-making.
